(19) United States
(12) Patent Application Publication
(10) Pub. No.: US 2014/0023937 A1
(43) Pub. Date: Jan. 23, 2014

(54) ELECTROLYTES INCLUDING AN ORGANOSILICON SOLVENT AND PROPYLENE CARBONATE FOR LITHIUM ION BATTERIES

(71) Applicants: Zhengcheng Zhang, Naperville, IL (US); Jian Dong, Sun Prairie, WI (US); Khalil Amine, Oak Brook, IL (US)

(72) Inventors: Zhengcheng Zhang, Naperville, IL (US); Jian Dong, Sun Prairie, WI (US); Khalil Amine, Oak Brook, IL (US)

(21) Appl. No.: 13/551,115

(22) Filed: Jul. 17, 2012

(51) Int. Cl. H01M 10/056

(52) U.S. Cl. 429/338; 429/341

(57) ABSTRACT

An electrolyte includes an organosilicon solvent, propylene carbonate, and a salt.

### GOVERNMENT RIGHTS

The United States Government has rights in this invention pursuant to Contract No. DE-AC02-06CH11357 between the U.S. Department of Energy and UChicago Argonne, LLC, representing Argonne National Laboratory.

### FIELD

The present technology is generally related to electrolyte solvents for lithium ion batteries.

### SUMMARY

In one aspect, an electrolyte includes an organosilicon solvent, propylene carbonate, and a salt. In any of the embodiments, a ratio of organosilicon solvent to propylene carbonate is from about 1:9 to about 9:1. In any of the embodiments, a concentration of the salt in the electrolyte is from about 0.5 M to about 1.5M. In any of the embodiments, a concentration of the salt in the electrolyte is from about 0.7 M to about 1.2M.

According to any of the embodiments, the organosilicon solvent is a compound of formula SiR¹R²R³OR⁴, where R¹ and R² are individually alkyl, aryl, alkoxy, or siloxy; R³ is alkyl, alkoxy, siloxy, —(CH₂CH₂O)ₙCH₃ or —(CH₂CH₂CH₂O)ₙCH₃, a

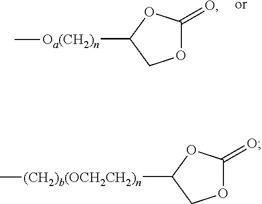

and R⁴ is —(CH₂CH₂O)ₙCH₃ or —(CH₂CH₂CH₂O)ₙCH₃; a is 0 or 1; b is 0, 1, 2, or 3; and n is from 1 to 20. In some embodiments, the organosilicon solvent includes Si(CH₃)₃[O(CH₂CH₂O)ₙCH₃]; Si(CH₃)₂[O(CH₂CH₂O)ₙCH₃][O(CH₂CH₂O)ₘCH₃]; Si(CH₃)₃OSi(CH₃)₂[O(CH₂CH₂O)ₙCH₃]; Si(CH₃)₃OSi(CH₃)₂[CH₂(CH₂CH₂O)ₙCH₃];
or

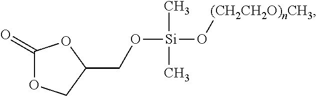

where n is from 1 to 20; and m is from 1 to 20.

In any of the above embodiments, of the electrolyte, the salt may include LiBr, LiI, LiSCN, LiBF₄, LiAlF₄, LiPF₆, LiAsF₆, LiClO₄, Li₂SO₄, LiB(Ph)₄, LiAlO₂, Li[N(FSO₂)₂], Li[SO₃CH₃], Li[BF₃(C₂F₅)], Li[PF₃(CF₂CF₃)₃], Li[B(C₂O₄)₂], Li[B(C₂O₄)F₂], Li[PF₄(C₂O₄)], Li[PF₂(C₂O₄)₂], Li[CF₃CO₂], Li[C₂F₅CO₂], Li[N(CF₃SO₂)₂], Li[C(SO₂CF₃)₃], Li[N(C₂F₅S0₂)₂], Li[CF₃SO₃], Li₂B₁₂X₁₂₋ₙHₙ, Li₂B₁₀X_{1-n′}H_{n′}, Li₂S_{x″}, (LiS_{x″}R¹)_{y}, (LiSe_{x″}R¹)_{y}, or lithium alkyl fluorophosphates; where X is a halogen, n is an integer from 0 to 12, n′ is an integer from 0 to 10, x″ is an integer from 1 to 20, y is an integer from 1 to 3, and R¹ is H, alkyl, alkenyl, aryl, ether, F, CF₃, COCF₃, SO₂CF₃, or SO₂F.

In another aspect, a lithium ion battery includes an anode, a cathode, and any of the above electrolytes.

### BRIEF DESCRIPTION OF THE DRAWINGS

FIG. 1 is a graph of cycling performance of a LiNi_{1/3}Mn_{1/3}Co_{1/3}O₂ (NMC) and mesocarbon microbead (MCMB) cell using 1NM3, PC, or 1NM3/PC co-solvent as the electrolytes, according to the examples.

FIG. 2 is a graph of cycling performance of a LiNi_{1/3}Mn_{1/3}Co_{1/3}O₂ (NMC)/MCMB cell using 1NM3/PC co-solvent as the electrolyte at C/5 charge/discharge rate, according to the examples.

FIG. 3 is a graph of cycling performance of LiMnO₂/modified artificial graphite (MAG) graphite cell using 1.2 M PF₆ in 1NM3/PC co-solvent or in 3:7 ethylene carbonate: ethyl methyl carbonate (Gen2) as the electrolytes at C/5 charge/discharge rate, according to the examples.

FIG. 4 is a series of FT-IR (Fourier Transform-Infrad Red) spectra of pure PC, PC with 1 M LiPF₆, and PC with 1 M LiPF₆ with 15 wt % 1NM3, according to the examples.

FIG. 5 is a series of FT-IR spectra of mixtures 1NM3 and PC, according to the examples.

FIG. 6 is a ⁷Li NMR spectral plot for various concentrations of 1NM3 in PC with 1 M LiPF₆, according to the examples.

FIG. 7 is a charging profile comparison of solvents incorporating PC with either 1NM3 and 2SM3, according to the examples.

FIG. 8 is a capacity profile graph for a full cell incorporating a mixture of PC and 1NM3 with Li[B(C₂O₄)₂], according to the examples.

FIG. 9 is a charging profile graph for a series of cells containing various ratios of PC to silane co-solvent, according to the examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Propylene carbonate (PC) possesses many favorable characteristics for use as an electrolyte in battery systems. For PC exhibits superior ionic conductivity at low temperature, low price, and high boiling point for use in the electrolytes of lithium ion batteries, however PC is not a suitable electrolyte component for lithium-ion batteries having a graphite anode. Upon first charging of a lithium ion battery incorporating PC in the electrolyte, the PC co-intercalates into graphite with the lithium. The large size of the PC causes severe exfoliation of the graphite layers, thereby leading to the destruction of the graphite structure. For example, see Besenhard et al. J. Power Sources 54 (1995) 228-231; Winter et al. Adv. Mater. 10 (1998) 725-763; and Zhang et al. J. Phys. Chem. C 111 (2007) 4740-4748. Further more, the coordination of the lithium to the PC causes free radical decomposition of the PC resulting in the production of gaseous propylene (see Scheme 1), which causes further exfoliation of the graphite particles, leading to the formation of an excessively thick passive layer, and hindering transport of lithium cations.

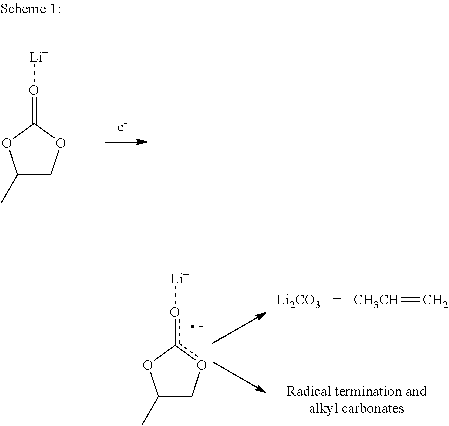

It has now been found that the use of an organosilicon compound as a co-solvent for propylene carbonate shows a significant synergic effect, which effectively suppresses PC decomposition and successfully eliminates the exfoliation of the graphite anode. The present inventors have found that surprisingly, organosilicon has a highly efficient performance in reducing the irreversible capacity at the anode side when PC-based electrolytes were used. Electrochemical cells incorporating the organosilicon-PC co-solvent electrolyte exhibit improved capacity retention property, thermal stability and extended temperature operation window (especially at low temperature).

Accordingly, in one aspect, an electrolyte is provided which includes a mixture of an organosilicon solvent and propylene carbonate along with a salt. It has been observed that this mixture of solvents provides for an unexpected effect in which lithium ion batteries employing such solvents exhibit improved capacity retention, thermal stability, and durability compared to lithium ion batteries employing only one of these materials. The effect is more than additive. Furthermore, the mixture of organosilicon solvent and propylene carbonate exhibit wider temperature operation window and are safer to use, with less flammability and toxicity, compared to conventional carbonate-based electrolytes, such as mixtures of ethylene carbonate and ethyl methyl carbonate.

In the electrolytes, it has been found that where approximately 10 wt % of the PC is replaced by the organosilicon solvent, the synergistic effects are observed and the intercalation of PC into the graphite is suppressed. However, larger loadings of the organosilicon may be used. In any of the above electrolytes, the ratio of organosilicon solvent to propylene carbonate is from about 1:9 to about 9:1. In some embodiments, this range may be from about 3:7 to about 7:3. In some embodiments, the ratio of organosilicon solvent to PC is about 1:1. In any of the electrolytes, the concentration of the salt in the electrolyte may be from about 0.5 M to about 1.5 M. This includes a salt concentration of about 0.7 to about 1.2 M, or a salt concentration of about 1 M to about 1.2 M.

The organosilicon solvent may be a compound of formula SiR¹R²R³OR⁴, where R¹ and R² are individually alkyl, aryl, alkoxy, or siloxy; R³ is alkyl, alkoxy, siloxy, —(CH₂CH₂O)ₙCH₃ or —(CH₂CH₂CH₂O)ₙCH₃,

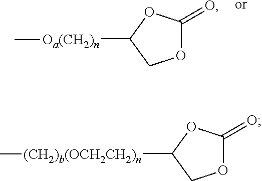

and R⁴ is −(CH₂CH₂O)ₙCH₃ or —(CH₂CH₂CH₂O)CH₃. Further with regard to the compound of formula SiR¹R²R³OR⁴, a is 0 or 1; b is 0, 1, 2, or 3; and n is from 1 to 20. In some embodiments, R¹, R², and R³ are individually C₁-C₆ alkyl or C₁-C₆ alkoxy; and R⁴ is —(CH₂CH₂O)ₙCH₃, where n is 1, 2, 3, 4, or 5. In other embodiments, R¹ and R² are individually C₁-C₆ alkyl; R³ is

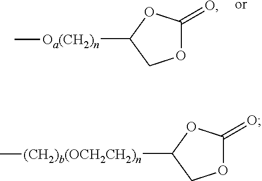

R⁴ is —(CH₂CH₂O)ₙCH₃ or —(CH₂CH₂CH₂O)ₙCH₃; and n is from 1, 2, 3, 4, or 5.

Illustrative organosilicon solvents of formula SiR¹R²R³OR⁴ include, but are not limited to, Si(CH₃)₃[O(CH₂CH₂O)ₙCH₃]; Si(CH₃)₂[O(CH₂CH₂O)ₙCH₃][O(CH₂CH₂O)ₘCH₃]; Si(CH₃)₃OSi(CH₃)₂[O(CH₂CH₂O)ₙCH₃]; Si(CH₃)₃OSi(CH₃)₂[CH₂(CH₂CH₂O)ₙCH₃]; and

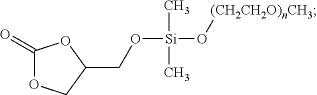

where n is from 1 to 20; and m is from 1 to 20. Where the solvent is Si(CH₃)₃O(CH₂CH₂O)₃CH₃, the compound is referred to as 1NM3. Where the solvent is Si(CH₃)₃OSi(CH₃)₂CH₂(CH₂CH₂O)₃CH₃, the compound is referred to as 2SM3.

As noted, the electrolyte also contains a salt. The salt may be a salt as known for use in a lithium ion battery. For example, the salt may be a lithium salt. Suitable lithium salts include, but are not limited to, LiBr, LiI, LiSCN, LiBF₄, LiAlF₄, LiPF₆, LiAsF₆, LiClO₄, Li₂SO₄, LiB(Ph)₄, LiAlO₂, Li[N(FSO₂)₂], Li[SO₃CH₃], Li[BF₃(C₂F₅)], Li[PF₃(CF₂CF₃)₃], Li[B(C₂O₄)₂], Li[B(C₂O₄)F₂], Li[PF₄(C₂O₄)], Li[PF₂(C₂O₄)₂], Li[CF₃CO₂], Li[C₂F₅CO₂], Li[N(CF₃S0₂)₂], Li[C(SO₂CF₃)₃], Li[N(C₂F₅SO₂)₂], Li[CF₃SO₃], Li₂B₁₂X₁₂₋ₙHₙ, Li₂B₁₀X_{10-n′}H_{n′}, Li₂S_{x″}, (LiS_{x″}R¹)_{y}, (LiSe_{x″}R¹)_{y}, and lithium alkyl fluorophosphates; where X is a halogen, n is an integer from 0 to 12, n′ is an integer from 0 to 10, x″ is an integer from 1 to 20, y is an integer from 1 to 3, and R¹ is H, alkyl, alkenyl, aryl, ether, F, CF₃, COCF₃, SO₂CF₃, or SO₂F. In any of the above embodiments, the salt includes Li[B(C₂O₄)₂], Li[B(C₂O₄)F₂], LiClO₄, LiBF₄, LiAsF₆, LiPF₆, LiCF₃SO₃, Li[N(CF₃SO₂)₂], Li[C(CF₃SO₂)₃], Li[N(SO₂C₂F₅)₂], or a lithium alkyl fluorophosphate.

In another aspect, a lithium ion battery is provided including an anode, a cathode, and an electrolyte, the electrolyte comprising an organosilicon solvent, propylene carbonate, and salt. The electrolyte may be any of the above electrolytes. With regard to the electrodes, they may be those as are known for use in lithium ion batteries. For example, the cathode may include, but is not limited to, a cathode active material that is a spinel, a olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiFeO₂, LiM⁴_{0.5}Mn_{1.5}O₄, Li_{1-x″}Ni_{α}Mn_{β}Co_{γ}M⁵_{δ′}O_{2-z″}F_{z″}, A_{n′}B¹₂(M²O₄)₃, or VO₂. In the cathode active materials, M⁴ is Al, Mg, Ti, B, Ga, Si, Mn, or Co; M⁵ is Mg, Zn, Al, Ga, B, Zr, or Ti; A is Li, Ag, Cu, Na, Mn, Fe, Co, Ni, Cu, or Zn; B¹ is Ti, V, Cr, Fe, or Zr; 0≦x≦0.3; 0≦y≦0.5; 0≦z≦0.5; 0≦m≦0.5; 0≦n≦0.5; 0≦x″≦0.4; 0≦α≦1; 0≦β≦1; 0≦γ≦1; 0≦δ′≦0.4; 0≦z″≦0.4; and 0≦n′≦3; with the proviso that at least one of α, β and γ is greater than 0. In some embodiments, the cathode includes LiFePO₄, LiCoO₂, LiNiO₂, LiNi₁₋ₓCo_{y}M⁴_{z}O₂, LiMn_{0.5}Ni_{0.5}O₂, LiMn_{1/3} Co_{1/3}Ni_{1/3}O₂, LiMn₂O₄. Additionally, the anode may include carbon materials including, but not limited to, synthetic graphite, natural graphite, amorphous carbon, hard carbon, soft carbon, acetylene black, mesocarbon microbeads (MCMB), carbon black, Ketjen black, mesoporous carbon, porous carbon matrix, carbon nanotube, carbon nanofiber, or graphene. In any of the above embodiments, the anode includes a graphite material.

The lithium ion batteries may also include a separator between the cathode and anode to prevent shorting of the cell. Suitable separators include those such as, but not limited to, a microporous polymer film that is nylon, cellulose, nitrocellulose, polysulfone, polyacrylonitrile, polyvinylidene fluoride, polypropylene, polyethylene, polybutene, or a blend or copolymer thereof. In some embodiments, the separator is an electron beam treated micro-porous polyolefin separator. In some embodiments, the separator is a shut-down separator. Commercially available separators include those such as, but not limited to, Celgard® 2025 and 3501, Tonen separators and ceramic-coated separators.

Without being bound by theory, the mechanism of the synergistic effect is believed to be explained as follows. In the above electrolytes and devices, it is believed that the organosilicon compound competes with the PC for coordination of lithium ions in the electrolyte. Where PC is the only or primary solvent, the PC effectively coordinates lithium ions and is co-intercalated into the graphite of the anode. However, it has now been found that where an organosilicon solvent is introduced with the PC in the electrolyte, the organosilicon solvent competes with the PC for coordination of lithium. Unlike most electrolyte solvents and other additives, which obey the empirical rule that the lowest unoccupied molecular orbitals (LUMOs) will be filled first. In other words, the thermodynamic of the solvation of solvent and Li is more favorable for a silane solvent than for propylene carbonate. The organosilicon solvent molecules first serve as a chelating agent for the lithium ions, thereby effectively blocking the PC from association with the lithium ions. The PC is then forced to be reduced on the surface via a single-electron process, an instead of interaction into the graphite, the PC forms a stable passive layer on the graphite surface.

Scheme 2 illustrates that which is believed to be occurring in the cells. Scheme 2 illustrates the trend from a PC solvent entirely complexing the lithium ion to where the organosilicon solvent (illustrated as 1NM3) protects the lithium ion from the PC.

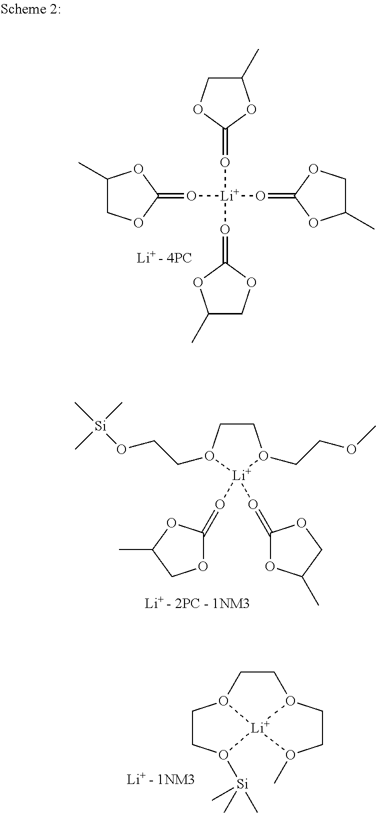

The present invention, thus generally described, will be understood more readily by reference to the following examples, which are provided by way of illustration and are not intended to be limiting of the present invention.

### EXAMPLES

### Example 1

2032 coin cells were prepared using a cathode of LiNi_{0.33}Mn_{0.33}Co_{0.33}O₂, an anode of mesocarbon microbeads, and a Cellgard 2325 separator. The electrolyte included 1 M LiPF₆ in the following solvents.

| Coin Cell | Solvent |
|---|---|
| 1 | 1NM3 |
| 2 | PC |
| 3 | 1NM3:PC at a ratio of 1:1 |

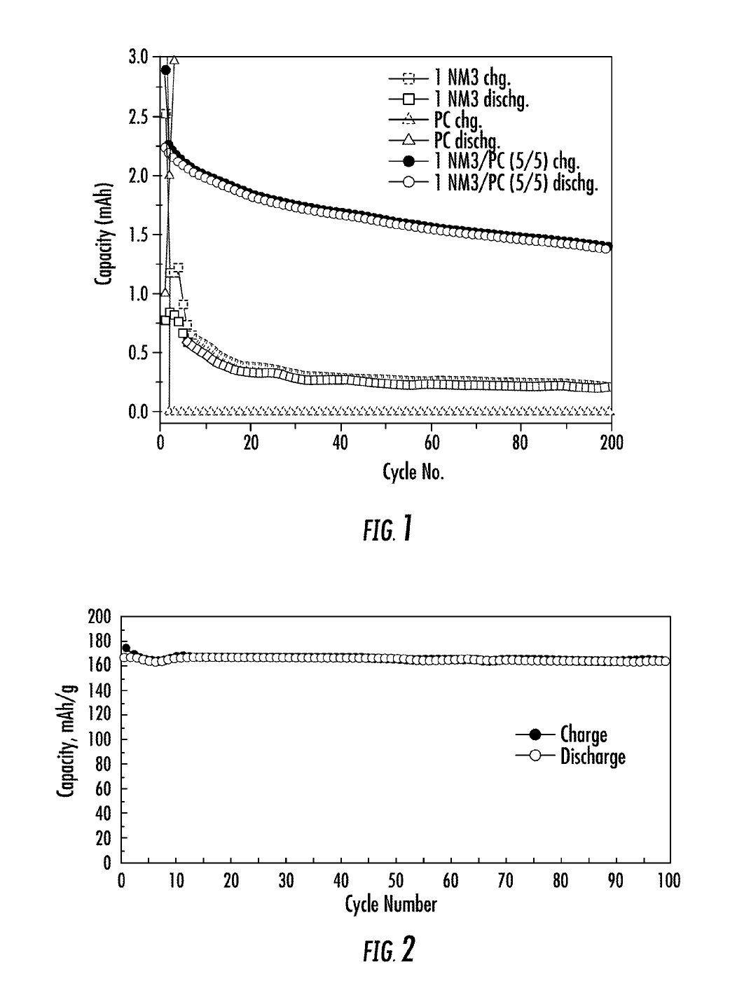

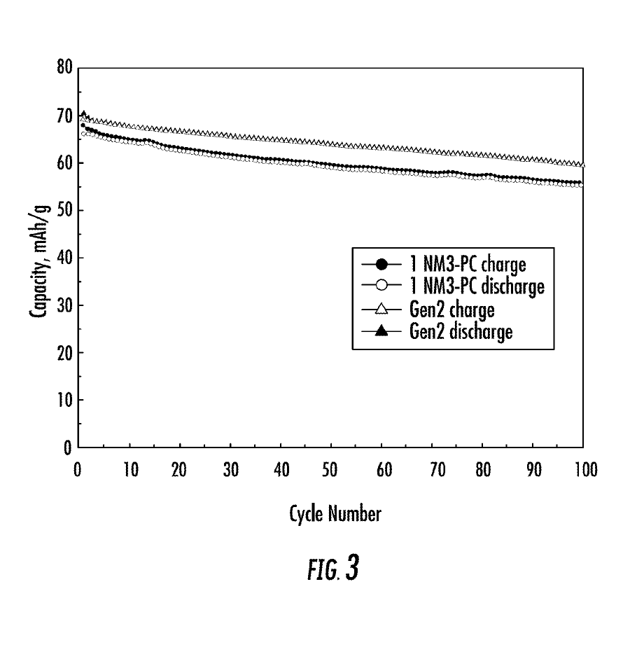

The cells were charged at a rate of C/2 to 4.2V until C/20 and discharged at a rate of C/2 to 2/7 V at 25° C. FIG. 1 clearly illustrates the synergism of the combination of an organosilicon solvent with PC. In FIG. 1, where PC or the 1NM3 are used individually, the capacity is poor, at best. However, where the solvents are combined, the capacity improves dramatically, with a 100% increase after the first cycle.

### Example 2

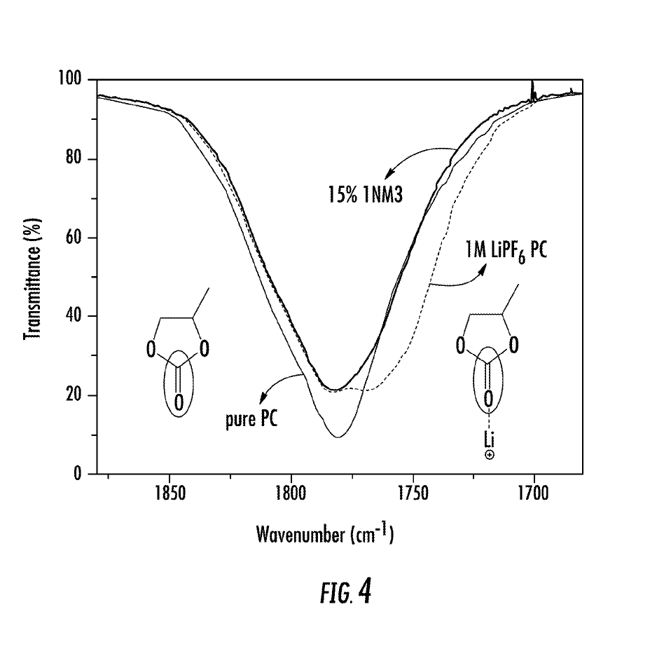

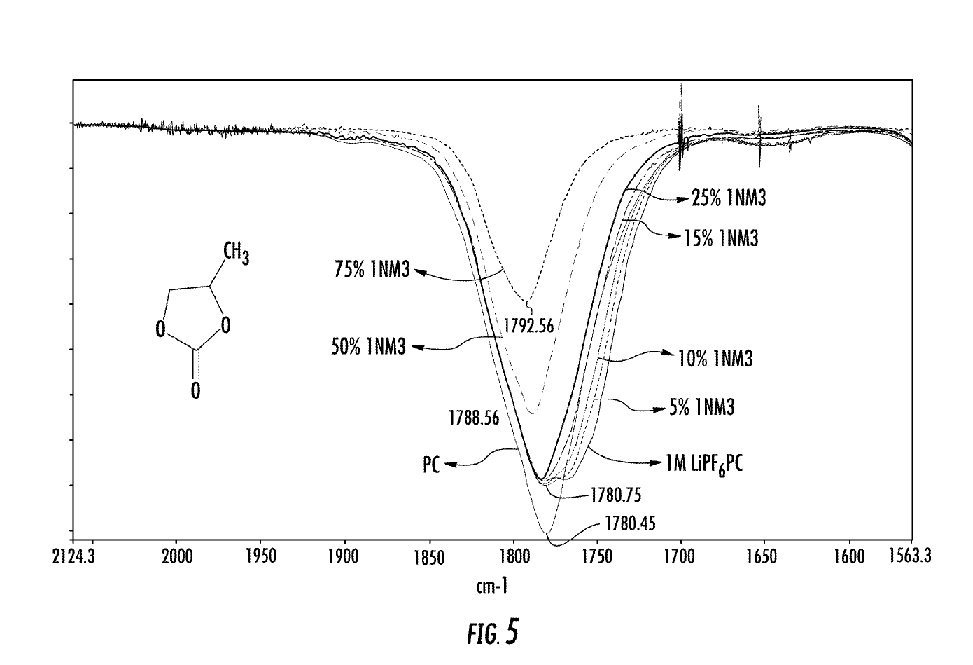

FT-IR analysis of mixtures of 1NM3 and PC was also conducted, with respect to the C═O resonance in the spectra. In FIG. 4, the FT-IR overlay spectra of a pure PC, PC with 1 M LiPF₆, and PC with 1 M LiPF₆ and 15 wt % 1NM3 are presented. As illustrated, the 1 M LiPF₆ in PC deviates markedly from the pure PC, with the C═O indicated a significant amount of weakening in the bond, the peak showing additional stretches to higher wavenumber. It is believed that the weaking of the bond is a due to an association of the solvation of the Li⁻ with the PC. However, when 15 wt % 1NM3 is added, the C═O peak of the PC is restored showing little to no interaction with the Li⁺. Thus, it is apparent that the silane solvent takes over as the solvating entity for the Li⁺. In FIG. 5, higher loadings of 1NM3 in the PC 1 M LiPF₆ are illustrated, with similar results. As the concentration of the 1NM3 increases, the amount of PC is reduced and accordingly the intensity of the peak is reduced.

### Example 3

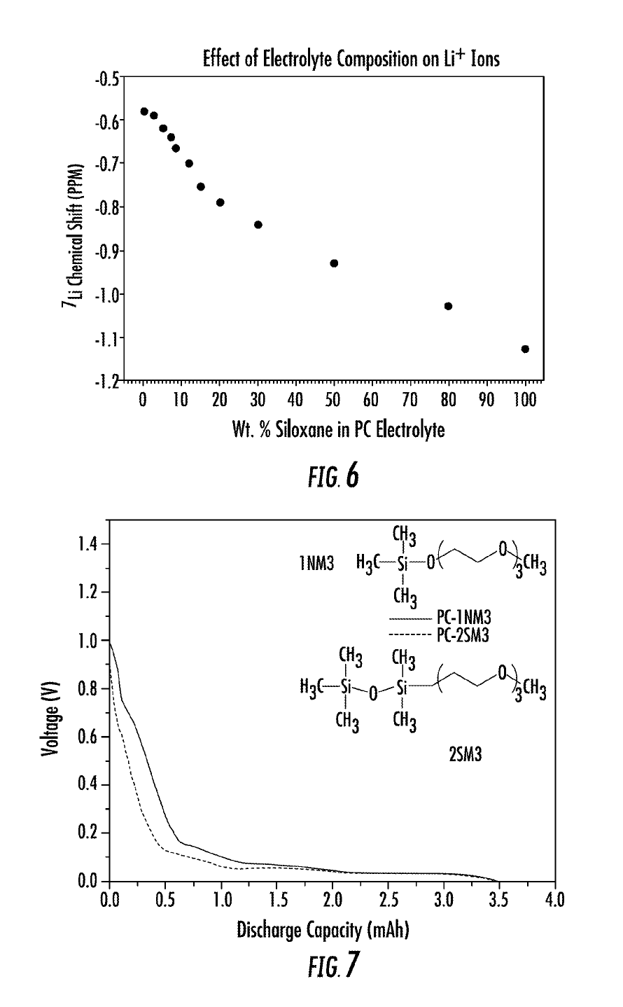

⁷Li NMR spectra were obtained of samples of 1 M LiPF₆ in PC with varying amounts of 1NM3 added. The spectral plot shown in FIG. 6, which plots shift against concentration shows that between about 10 and 20 wt % 1NM3 an inflection occurs. It is believed that this is a showing that the PC is no longer coordinating to the Li⁺ and the predominant species is the 1NM3-Li⁺ complex.

### Example 4

2032 coin cells (half cells) were prepared using a cathode of graphite, an anode of lithium, and a Cellgard 3501 separator. The electrolyte included 1 M LiPF₆ in PC with either 50 wt % 1NM3 or 2SM3. The cells were charged at a rate of C/20 to 0.01 V. The voltage v. discharge capacity graphs for the two cells are show in FIG. 7. The cell with the 2SM3 performed slightly better than that with the 1NM3, but both were acceptable.

### Example 5

Full cell 2032 coin cells were prepared using a cathode of LiNi_{0.33}Mn_{0.33}Co_{0.33}O₂, an anode of mesocarbon microbeads, and a Cellgard 2325 separator. The electrolyte included 1 M LiPF₆ in PC:1NM3 (7:3) with 2 wt % Li[B(C₂O₄)₂]. The cells were charged at a rate of C/2 to 4.2V until C/20 and discharged at a rate of C/2 to 3.0 V at 25° C. The cell exhibits remarkable stability as illustrated by the capacity v. cycle graph presented in FIG. 8.

### Example 6

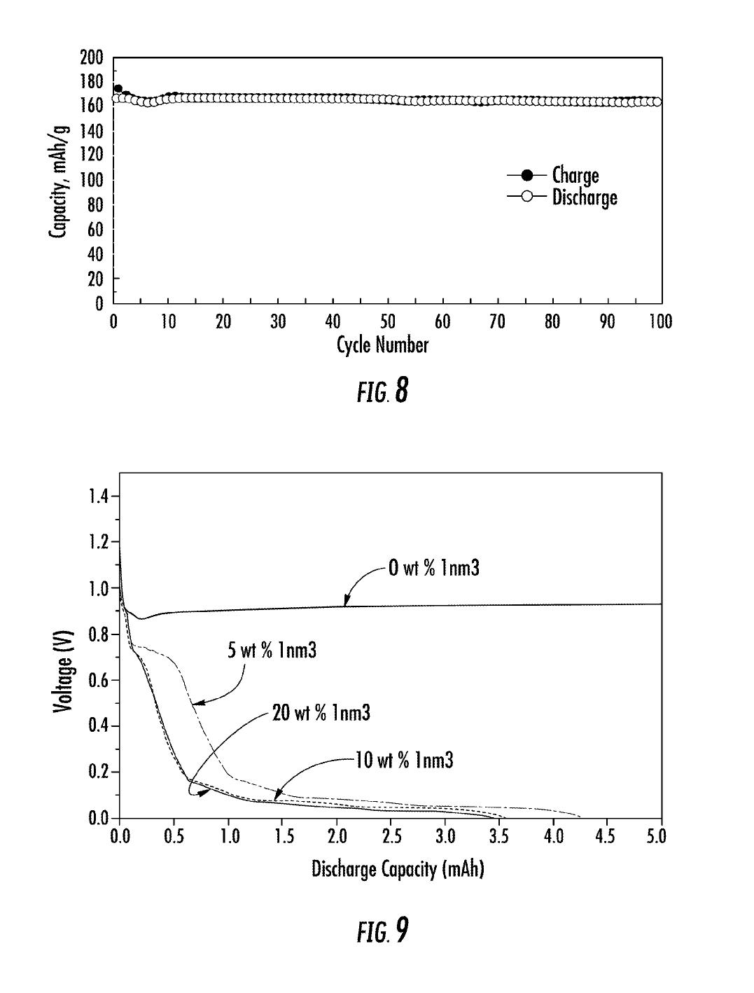

A series of 2032 coin cells were prepared using a cathode of MCMB graphite, an anode of Li, and a Cellgard 3501 separator. One cell contained an electrolyte of 1 M LiPF₆ in PC. Another cell contained 1M LiPF₆ in PC with 5 wt % 1NM3. A third cell contained 1M LiPF₆ in PC with 10 wt % 1NM3. A fourth cell contained 1M LiPF₆ in PC with 20 wt % 1NM3. The results of the charging profiles are overlayed in FIG. 9. As shown, the PC provides very poor results with the PC being intercalated irreversibly into the graphite only minimal Li⁺ intercalation. However, upon inclusion of 5 wt % silane, the discharge capacity is markedly improved, with additional improvement upon inclusion of 10 wt % silane. Higher loadings of silane (20 wt %) did not provide a significant increase in performance.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrolyte comprising:
propylene carbonate;
a salt; and
an organosilicon solvent of formula SiR¹R²R³OR⁴;
wherein:
R¹ and R² are individually alkyl, aryl, alkoxy, or siloxy;
R³ is alkyl, alkoxy, siloxy, —(CH₂CH₂O)ₙCH₃ or —(CH₂CH₂CH₂O)ₙCH₃, a 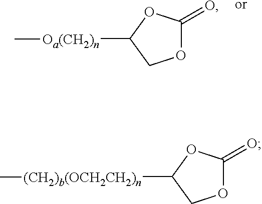
and
R⁴ is —(CH₂CH₂O)ₙCH₃ or —(CH₂CH₂CH₂O)ₙCH₃;
a is 0 or 1;
b is 0, 1, 2, or 3; and
n is from 1 to 20.

2. The electrolyte of claim 1, wherein a ratio of organosilicon solvent to propylene carbonate is from about 1:9 to about 9:1.

3. The electrolyte of claim 1, wherein a ratio of organosilicon solvent to propylene carbonate is from about 3 :7 to about 7:3.

4. The electrolyte of claim 1, wherein the concentration of the salt in the electrolyte is from about 0.5 M to about 1.5 M.

5. The electrolyte of claim 1, wherein the concentration of the salt in the electrolyte is from about 1 M to about 1.2 M.

6. The electrolyte of claim 1, wherein R¹, R², and R³ are individually C₁-C₆ alkyl or C₁-C₆ alkoxy; and R⁴ is —(CH₂CH₂O)ₙCH₃, where n is from 1 to 5.

7. The electrolyte of claim 1, wherein the organosilicon solvent comprises Si(CH₃)₃[O(CH₂CH₂O)ₙCH₃]; Si(CH₃)₂[O(CH₂CH₂O)ₙCH₃][O(CH₂CH₂O)ₘCH₃]; Si(CH₃)₃OSi(CH₃)₂[O(CH₂CH₂O)ₙCH₃]; Si(CH₃)₃OSi(CH₃)₂[CH₂(CH₂CH₂O)ₙCH₃]; or 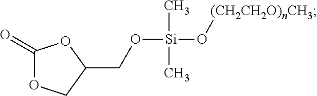
n is from 1 to 20; and
m is from 1 to 20.

8. The electrolyte of claim 1, wherein the organosilicon solvent comprises (CH₃)₃SiO(CH₂CH₂O)₃CH₃ or (CH₃)₃SiOSi(CH₃)₂CH₂(CH₂CH₂O)₃CH₃.

9. The electrolyte of claim 1, wherein the salt comprises LiBr, LiI, LiSCN, LiBF₄, LiAlF₄, LiPF₆, LiAsF₆, LiClO₄, Li₂SO₄, LiB(Ph)₄, LiAlO₂, Li[N(FSO₂)₂], Li[SO₃CH₃], Li[BF₃(C₂F₅)], Li[PF₃(CF₂CF₃)₃], Li[B(C₂O₄)₂], Li[B(C₂O₄)F₂], Li[PF₄(C₂O₄)], Li[PF₂(C₂O₄)₂], Li[CF₃CO₂], Li[C₂F₅CO₂], Li[N(CF₃SO₂)₂], Li[C(SO₂CF₃)₃], Li[N(C₂F₅SO₂)₂], Li[CF₃SO₃], Li₂B₁₂X₁₂₋ₙHₙ, Li₂B₁₀X_{10-n′}H_{n′}, Li₂S_{x″}, (LiS_{x″}R¹)_{y}, (LiSe_{x″}R¹)_{y}, or a lithium alkyl fluorophosphate; where X is a halogen, n is an integer from 0 to 12, n′ is an integer from 0 to 10, x″ is an integer from 1 to 20, y is an integer from 1 to 3, and R¹ is H, alkyl, alkenyl, aryl, ether, F, CF₃, COCF₃, SO₂CF₃, or SO₂F.

10. The electrolyte of claim 1, wherein the salt comprises Li[B(C₂O₄)₂], Li[B(C₂O₄)F₂], LiClO₄, LiBF₄, LiAsF₆, LiPF₆, LiCF₃SO₃, Li[N(CF₃SO₂)₂], Li[C(CF₃SO₂)₃], Li[N(SO₂C₂F₅)₂], or a lithium alkyl fluorophosphate.

11. A lithium ion battery comprising an anode, a cathode, and an electrolyte, the electrolyte comprising propylene carbonate, a salt, and an organosilicon solvent of formula SiR¹R²R³OR⁴;
wherein:
R¹ and R² are individually alkyl, aryl, alkoxy, or siloxy;
R³ is alkyl, alkoxy, siloxy, —(CH₂CH₂O)ₙCH₃ or —(CH₂CH₂CH₂O)ₙCH₃, a 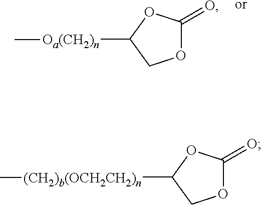
and
R⁴ is —(CH₂CH₂O)ₙCH₃ or —(CH₂CH₂CH₂O)ₙCH₃;
a is 0 or 1;
b is 0, 1, 2, or 3; and
n is from 1 to 20.

12. The lithium ion battery of claim 11, wherein a ratio of organosilicon solvent to propylene carbonate in the electrolyte is from about 1:9 to about 9:1.

13. The lithium ion battery of claim 11, wherein a ratio of organosilicon solvent to propylene carbonate in the electrolyte is from about 3:7 to about 7:3.

14. The lithium ion battery of claim 11, wherein the concentration of the salt in the electrolyte is from about 0.5 M to about 1.5 M.

15. The lithium ion battery of claim 11, wherein the concentration of the salt in the electrolyte is from about 1 M to about 1.2 M.

16. The lithium ion battery of claim 11, wherein the organosilicon solvent comprises Si(CH₃)₃[O(CH₂CH₂O)ₙCH₃]; Si(CH₃)₂[O(CH₂CH₂O)ₙCH₃][O(CH₂CH₂O)ₘCH₃]; Si(CH₃)₃OSi(CH₃)₂[O(CH₂CH₂O)ₙCH₃]; Si(CH₃)₃OSi(CH₃)₂[CH₂(CH₂CH₂O)ₙCH₃]; and 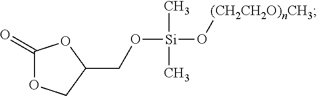
n is from 1 to 20; and
m is from 1 to 20.

17. The lithium ion battery of claim 11, wherein the cathode comprises a spinel, a olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiFeO₂, LiM⁴_{0.5}Mn_{1.5}O₄, Li_{1+x″}Ni_{α}Mn_{β}Co_{γ}M⁵_{δ′}O_{2-z″}F_{z″}, A_{n′}B¹₂(M²O₄)₃, or VO₂, wherein M⁴ is Al, Mg, Ti, B, Ga, Si, Mn, or Co; M⁵ is Mg, Zn, Al, Ga, B, Zr, or Ti; A is Li, Ag, Cu, Na, Mn, Fe, Co, Ni, Cu, or Zn; B¹ is Ti, V, Cr, Fe, or Zr; 0≦x≦0.3; 0≦y≦0.5; 0≦z≦0.5; 0≦m≦0.5; 0≦n≦0.5; 0≦x″≦0.4; 0≦α≦1; 0≦β≦1; 0≦γ≦1; 0≦δ′≦0.4; 0≦z″≦0;4; and 0≦n′≦3; with the proviso that at least one of α, β and γ is greater than 0.

18. The lithium ion battery of claim 11, wherein the anode comprises synthetic graphite, natural graphite, amorphous carbon, hard carbon, soft carbon, acetylene black, mesocarbon microbeads (MCMB), carbon black, Ketjen black, mesoporous carbon, porous carbon matrix, carbon nanotube, carbon nanofiber, or graphene.
